(19) United States
(12) Patent Application Publication
(10) Pub. No.: US 2015/0200559 A1
(43) Pub. Date: Jul. 16, 2015

(54) BATTERY SYSTEM AND ENERGY STORAGE SYSTEM INCLUDING THE SAME

(71) Applicant: Samsung SDI Co., Ltd., Yongin-si (KR)

(72) Inventor: Jae-Sung Im, Yongin-si (KR)

(21) Appl. No.: 14/559,774

(22) Filed: Dec. 3, 2014

(30) Foreign Application Priority Data
Jan. 15, 2014 (KR) 10-2014-0005204

(51) Int. Cl. H02J 7/00

(52) U.S. Cl. CPC H02J 7/0063

(57) ABSTRACT

A battery system and an energy storage system including the same are disclosed. In one aspect, the energy storage system comprises a battery system and a power conversion system configured to convert power between a load and the battery system. The battery system includes a plurality of trays, a rack and a rack manager. Each tray includes a battery and a first contact, wherein the batteries are configured to output power. The rack includes a plurality of slots configured to respectively receive the trays, wherein each slot comprises a second contact corresponding to the first contact. The rack manager is configured to charge a load based on the power when the first and second contacts are connected and stop charging the load on the power when at least one of the first contacts is separated from the second contact corresponding to the first contact.

### RELATED APPLICATIONS

This application claims the benefit of Korean Patent Application No. 10-2014-0005204, filed on Jan. 15, 2014, in the Korean Intellectual Property Office, the disclosure of which is incorporated herein in its entirety by reference.

### BACKGROUND

1. Field

The described technology generally relates to a battery system and an energy storage system including the same.

2. Description of the Related Technology

An energy storage system is a storage medium for improving energy efficiency and achieving stable power management of a power grid. This occurs by storing electric power when there is low demand for electric power and using the stored electric power when there is high demand. With the recent proliferation of smart grids and renewable energy research and a recent emphasis on the efficiency and stability of a power grid, demand for an energy storage system that can supply power, adjust power demand, and improve power quality is gradually increasing.

### SUMMARY OF CERTAIN INVENTIVE ASPECTS

One inventive aspect is a battery system of which charging or discharging is stopped by mechanically sensing separation of a tray, and an energy storage system including the battery system.

Another aspect is a battery system includes a plurality of trays each of which includes a battery and a first contact, a rack including a plurality of slots in which the plurality of trays are inserted respectively and which include second contacts corresponding to the first contacts respectively, a plurality of connectors which include the first contacts and the second contacts, and which are closed when the plurality of trays are inserted in correct positions of the slots, and are opened when the plurality of trays are separated from the slots, a rack managing unit which controls the plurality of trays, and a power control unit which transfers drive power from the batteries to the rack managing unit based on a close control signal transferred through the connectors, and blocks the drive power transferred to the rack managing unit based on an open control signal generated by an opened connector among the connectors.

In an embodiment of the described technology, the plurality of connectors can transfer the close control signal when first and second contacts of each of the plurality of connectors come in contact with each other, and can transfer the open control signal when first and second contacts of any one of the plurality of connectors are separated from each other.

In an embodiment of the described technology, the power control unit can include a plurality of diodes which are connected to the plurality of trays respectively, and a switch which is connected between the plurality of diodes and the rack managing unit, and is closed or opened based on the close control signal or the open control signal.

In an embodiment of the described technology, the battery system can further include a divider unit which generates the close control signal from a node between the plurality of diodes and the switch.

In an embodiment of the described technology, the plurality of connectors can be connected in series between the divider unit and the switch, the close control signal can be input to the switch when all the plurality of connectors are in a close state, and the close control signal may not be transferred to the switch but the open control signal can be transferred to the switch when any one of the plurality of connectors is in an open state

In an embodiment of the described technology, each of the plurality of trays can include a battery tray, a tray managing unit which is driven by drive power supplied from the rack managing unit, monitors an operation situation of the tray, and transfers results of the monitoring to the rack managing unit, and a switch which connects the battery tray to a high current path based on a switching control signal of the tray managing unit.

In an embodiment of the described technology, the switch can be turned off when the tray managing unit is turned off.

In an embodiment of the described technology, the battery system can further include a charge/discharge control switch which is prepared in a high current path between the plurality of trays and a terminal, and controls flow of current in the high current path based on a first switching control signal of the rack managing unit.

In an embodiment of the described technology, the first switching control signal can be deactivated when the rack managing unit is turned off, and the charge/discharge control switch can be turned off in response to the deactivated first switching control signal.

In an embodiment of the described technology, the battery system can further include a precharge control switch and a precharge resistor which are prepared in a precharge path connected in parallel with at least a part of the high current path, and controlled based on a second switching control signal of the rack managing unit.

In an embodiment of the described technology, the second switching control signal can be deactivated when the rack managing unit is turned off, and the precharge control switch can be turned off in response to the deactivated second switching control signal.

Another aspect is an energy storage system includes a battery system including a plurality of trays each of which includes a battery and a first contact, a rack including a plurality of slots in which the plurality of trays are inserted respectively and which include second contacts corresponding to the first contacts respectively, a plurality of connectors which include the first contacts and the second contacts, and which are closed when the plurality of trays are inserted in correct positions of the slots, and are opened when the plurality of trays are separated from the slots, a rack managing unit which controls the plurality of trays, and a power control unit which transfers drive power from the batteries to the rack managing unit based on a close control signal transferred through the connectors and blocks the drive power transferred to the rack managing unit based on an open control signal generated by an opened connector among the connectors, and a power conversion system which includes an electric generation system, a grid, power conversion devices converting power between a load and the battery system, and an integrated controller controlling the power conversion devices.

Another aspect is a battery system comprising a plurality of trays each including a battery and a first contact, wherein the batteries are configured to provide drive power. The battery system further comprises a rack including a plurality of slots configured to respectively receive the trays, wherein each slot comprises a second contact corresponding to the first contact. The battery system further comprises a rack manager configured to charge a load based on the drive power, and a power controller configured to i) transfer the drive power from the batteries to the rack manager when the first and second contacts are connected and ii) not transfer the driver power from the batteries to the rack manager when at least one of the first contacts is separated from the corresponding second contact.

In the above battery system, the power controller is configured to i) provide a close control signal when the first and second contacts are connected and ii) provide an open control signal when the at least one first contact is separated from the corresponding second contact, wherein the rack manager is configured to charge the load based on the close control signal and stop charging the load based on the open control signal. In the above battery system, the power controller comprises a plurality of diodes respectively electrically connected to the trays, and a switch electrically connected between the diodes and the rack manager, wherein the switch is configured to be respectively closed and opened based on the close control signal and the open control signal.

The above battery system further comprises a divider configured to output the close control signal from a node between the diodes and the switch. In the above battery system, the divider is configured to output the open control signal from the node.

In the above battery system, each of the trays comprises a battery tray, a tray manager configured to be driven by the drive power, wherein the tray manager is configured to monitor an operation state of the battery tray, and wherein the tray manager is configured to provide the monitored operation state to the rack manager. The above battery system, each of the trays further comprises a switch configured to electrically connect the battery tray to a high current path based on a switching control signal received from the tray manager.

In the above battery system, the switch is configured to be turned off when the tray manager is turned off. The above battery system further comprises a charge/discharge control switch placed in a high current path between the trays and a voltage terminal, wherein the charge/discharge control switch is configured to control a current flow in the high current path based on a first switching control signal received from the rack manager. In the above battery system, the charge/discharge control switch is configured to be turned off when the rack manager is turned off.

The above battery system further comprises a precharge circuit including a precharge control switch and a precharge resistor, wherein the precharge circuit is located in a precharge path connected in parallel with at least a portion of the high current path, and wherein the precharge circuit is configured to be controlled based on a second switching control signal received from the rack manager. In the above battery system, the precharge control switch is configured to be turned off when the rack manager is turned off.

Another aspect is an energy storage system, comprising a battery system and a power conversion system. The battery system includes a plurality of trays each including a battery and a first contact, wherein the batteries are configured to provide drive power. The battery system further includes a rack including a plurality of slots configured to respectively receive the trays, wherein each slot comprises a second contact corresponding to the first contact. The battery system further includes a rack manager configured to charge a load based on the drive power, and a power controller configured to i) transfer the drive power from the batteries to the rack manager when the first and second contacts are connected and ii) not transfer the driver power from the batteries to the rack manager when at least one of the first contacts is separated from the corresponding second contact. The power conversion system is configured to convert the drive power between the load and the battery system.

Another aspect is an energy storage system, comprising a battery system and a power conversion system. The battery system includes a plurality of trays each including a battery and a first contact, wherein the batteries are configured to output power. The battery system further includes a rack including a plurality of slots configured to respectively receive the trays, wherein each slot comprises a second contact corresponding to the first contact. The battery system further includes a rack manager configured to charge a load based on the power when the first and second contacts are connected and stop charging the load when at least one of the first contacts is separated from the second contact corresponding to the first contact. The power conversion system is configured to convert the power between the load and the battery system.

In the above energy storage system, the rack manager is configured to sense a close control signal when the first and second contacts are connected and sense an open control signal when the at least one first contact is separated from the corresponding second contact, wherein the rack manager is configured to charge the load based on the close control signal and stop charging the load based on the open control signal. In the above energy storage system, the battery system further includes a power controller configured to transfer the power from the batteries to the rack manager. In the above energy storage system, the power controller comprises a plurality of diodes respectively electrically connected to the trays, and a switch electrically connected between the diodes and the rack manager, wherein the switch is configured to be respectively closed and opened based on the close control signal and the open control signal.

### BRIEF DESCRIPTION OF THE DRAWINGS

FIG. 1 is a block diagram of a battery system according to an embodiment.

FIG. 2 shows opening and closing of a tray according to an embodiment.

FIG. 3 is a block diagram of a battery system according to another embodiment.

FIG. 4 is a block diagram of an energy storage system according to an embodiment and peripheral components.

FIG. 5 is a block diagram of an energy storage system according to an embodiment.

### DETAILED DESCRIPTION OF CERTAIN INVENTIVE EMBODIMENTS

Trays including batteries can be electrically connected in parallel during a charging or discharging operation. When a tray is separated from an energy storage system, instantaneous overcurrent can flow to the remaining trays, or a voltage difference can occur between trays, thereby causing a failure in the energy storage system.

The described technology allows various kinds of modification and can have many embodiments, and particular embodiments are illustrated in the drawings and described in detail herein. However, it is to be understood that the particular embodiments do not limit the described technology to a particular embodiment but include every modified, equivalent, or replaced one within the spirit and technical cope of the described technology. Embodiments disclosed herein are provided so that this disclosure will be thorough and complete and will fully convey the scope of the described technology to those of ordinary skill in the art. In the description of the described technology, when it is determined that the detailed description of the related art would obscure the gist of the described technology, the detailed description thereof will be omitted.

The terminology used in this application is used to describe particular embodiments and is not intended to limiting the described technology. An expression in the singular includes an expression in the plural unless they are clearly different from each other in context. In this application, terms, such as “include” and “have”, are used to indicate the existence of features, numbers, steps, operations, elements, parts, or combinations thereof mentioned herein without excluding in advance the possibility of existence or addition of one or more other features, numbers, steps, operations, elements, parts, or combinations thereof. Although terms, such as “first” and “second”, can be used to describe various elements, the elements are not limited by these terms. These terms are only used to differentiate one element from another element. As used herein, the term “and/or” includes any and all combinations of one or more of the associated listed items. Expressions such as “at least one of,” when preceding a list of elements, modify the entire list of elements and do not modify the individual elements of the list.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections can be present in a practical device. Moreover, no item or component is essential to the practice of the described technology unless the element is specifically described as “essential” or “critical”.

The use of the terms “a” and “an” and “the” and similar referents in the context of describing the described technology (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited here.

The steps of all methods described herein can be performed in any suitable order unless otherwise indicated herein or otherwise clearly contradicted by context. The use of any and all examples, or exemplary language (e.g., “such as”) provided herein, is intended merely to better illuminate the described technology and does not pose a limitation on the scope of the described technology unless otherwise claimed. Numerous modifications and adaptations will be readily apparent to those of ordinary skill in this art without departing from the spirit and scope of the described technology.

Hereinafter, various embodiments will be described more fully with reference to the accompanying drawings. In the description with reference to the drawings, like reference numerals in the drawings denote like elements, and repetitive descriptions thereof will be omitted.

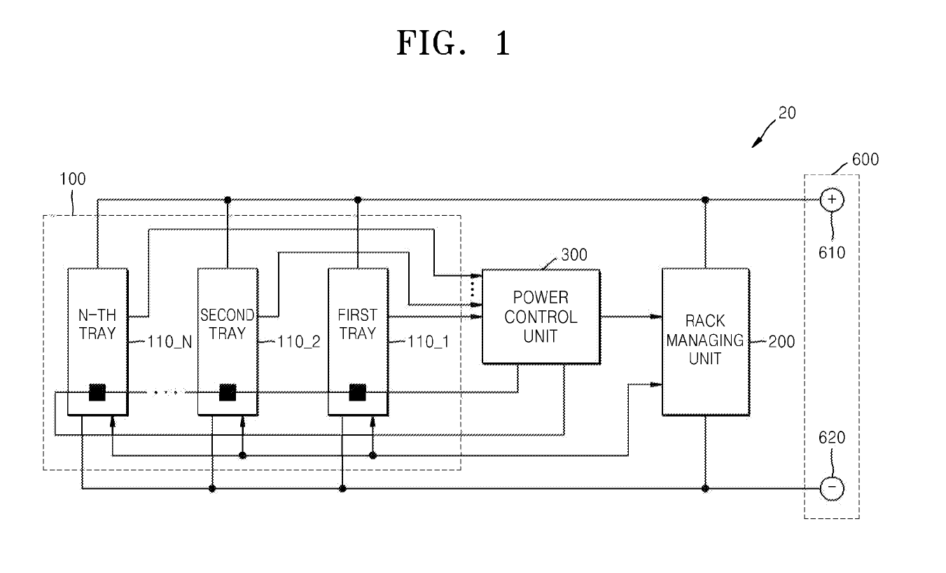

FIG. 1 is a block diagram of a battery system according to an embodiment.

Referring to FIG. 1, a battery system 20 includes a battery rack 100, a rack managing unit or a rack manager 200, and a power control unit or a power controller 300.

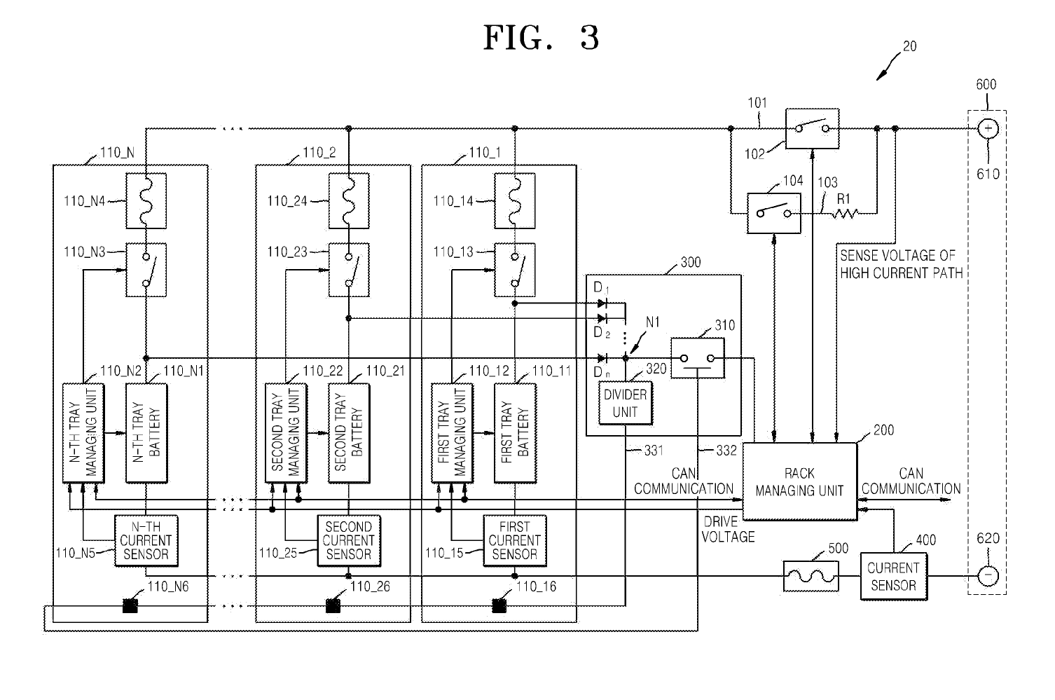

The battery rack 100 is a sub-unit and can include at least one tray, for example, a first tray 110_1 to an N-th tray 110_N, connected in series and/or parallel. Each of the first to N-th trays 110_1 to 110_N can include at least one battery and have a first contact. As shown in FIG. 3 which will be described later, the first to N-th trays 110_1 to 110_N respectively includes first to N-th tray batteries 110_11 to 110_N1 and first to N-th tray managing units 110_12 to 110_N2 respectively corresponding to the first to N-th tray batteries 110_11 to 110_N1. Each of the first to N-th tray batteries 110_11 to 110_N1 can include at least one battery cell as its sub-unit. Various secondary batteries can be used as the battery cell. For example, the secondary battery used as the battery cell can be a nickel-cadmium (NiCd) battery, a lead storage battery, a nickel metal hydride (NiMH) battery, a lithium ion battery, a lithium polymer battery, but is not limited thereto.

The battery rack 100 includes a plurality of slots (not shown) in which the first to N-th trays 110_1 to 110_N are inserted respectively. The slots have second contacts corresponding to the first contacts.

In addition, the first to N-th trays 110_1 to 110_N can include first to N-th connectors or first to N-th connecting regions 110_16 to 110_N6, respectively. The first to N-th connectors 110_16 to 110_N6 are connected to each other in series. The first to N-th connectors 110_16 to 110_N6 are collectively called connectors 110_6. Each of the connectors 110_6 includes a first contact 110_7 and a second contact 110_8. The connectors 110_6 can be closed when the trays 110 are inserted in the correct positions of the slots, and opened when the trays 110 are separated from the slots.

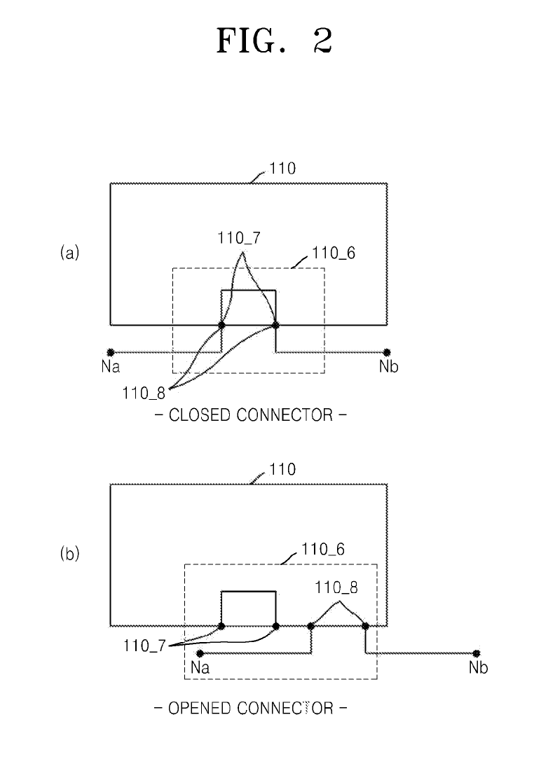

FIGS. 2A and 2B show opening and closing of a connector 110_6 according to the position of a tray 110. Referring to FIG. 2A, the tray 110 inserted in the correct position of a slot is shown. The first contact 110_7 and the second contact 110_8 come in contact with each other, and both terminals of the connector 110_6, that is, first and second nodes Na and Nb, are closed. Referring to FIG. 2B, the tray 110 separated from the slot is shown. The first and second contacts 110_7 and 110_8 of the connector 110_6 are separated from each other, and both the terminals of the connector 110_6, that is, the first and second nodes Na and Nb, are opened.

As shown in FIGS. 2A and 2B, the first contact 110_7 can include two terminals connected to each other, and the second contact 110_8 can include two terminals separated from each other. When the first and second contacts 110_7 and 110_8 come in contact with each other, the two terminals of the second contact 110_8 are electrically connected to each other through the two terminals of the first contact 110_7. The connector 110_6 of FIGS. 2A and 2B is exemplary and can have other shapes and configurations.

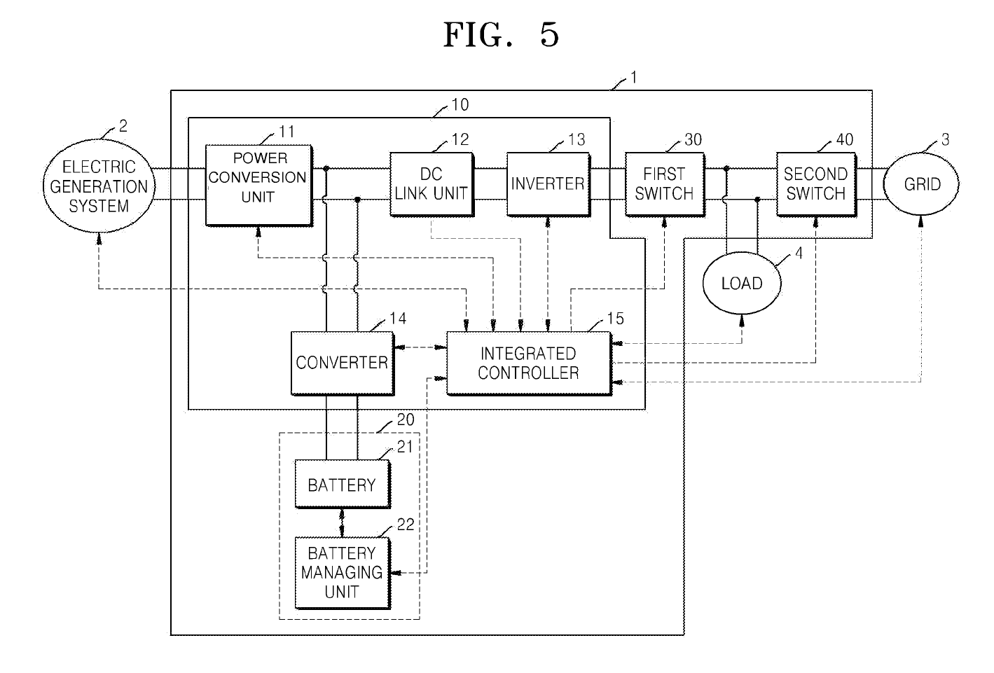

The rack managing unit 200 is connected to the battery rack 100, and controls charging and discharging operations of the battery rack 100. Also, the rack managing unit 200 can perform an overcharge prevention function, an over-discharge prevention function, an overcurrent protection function, an overvoltage protection function, an overheat protection function, a cell balancing function, etc. To this end, the rack managing unit 200 can transmit a synchronization signal to the battery rack 100, and can receive monitoring data about a voltage, current, temperature, remaining power, life span, state of charge (SOC), etc., from the first to N-th trays 110_1 to 110_N at intervals. Also, the rack managing unit 200 can apply the received monitoring data to the outside of the battery system 20 (e.g., an integrated controller 15 of FIG. 5). The rack managing unit 200 can receive a command to control the battery rack 100 from the outside (e.g., the integrated controller 15). Here, controller area network (CAN) communication can be used as a communication method among the battery rack 100, the rack managing unit 200, and the outside. However, the communication method is not limited to CAN communication, and various communication methods using a bus line can be used. In addition, communication methods using no bus line can be used as well. The rack managing unit 200 can receive drive power from the first to N-th trays 110_1 to 110_N through the power control unit 300.

The power control unit 300 can transmit the drive power from the first to N-th trays 110_1 to 110_N to the rack managing unit 200 based on a close control signal transmitted through the first to N-th connectors 110_16 to 110_N6. The power control unit 300 can block the drive power based on an open control signal transmitted through the first to N-th connectors 110_16 to 110_N6.

An exemplary operation of the power control unit 300 is described as follows. When any one of the first to N-th trays 110_1 to 110_N is separated from a slot, first and second contacts 110_N7 and 110_N8 of any one of the first to N-th connectors 110_16 to 110_N6 are separated. The open control signal is input to the power control unit 300. Then, the power control unit 300 can block the drive power transmitted from the first to N-th trays 110_1 to 110_N to the rack managing unit 200. When the drive power supplied to the rack managing unit 200 is blocked, the rack managing unit 200 is turned off, and the charging or the discharging of the battery system 20 is stopped.

As described above, separation of the trays 110 can be mechanically sensed by the connectors 110_6. When any one of the trays 110 is separated from a slot, drive power supplied to the rack managing unit 200 can be blocked so that the charging or the discharging of the battery system 20 can be stopped. Typically, when a non-mechanical sensor is used to sense separation of the tray 110, separation of the tray may not be sensed due to a failure or defect of the sensor. Also, a sensor is expensive compared to the mechanical connectors 110_6 and involves an additional circuit for processing a signal thereof. However, the mechanical connectors 110_6 of an embodiment can be simply implemented and also have a low probability of failure due to their simple structure. Therefore, a problem caused when separation of a tray 110 is not sensed normally due to a failure of a sensor, etc. can be prevented. For example, a problem of instantaneous overcurrent flowing to the remaining trays 110 that have not been separated or a problem of a voltage difference occurring between trays 110 can be prevented. As a result, the battery system 20 can be driven safely.

FIG. 3 is a block diagram of a battery system according to another embodiment.

Referring to FIG. 3, the battery system 20 includes a high current path 101, a charge/discharge control switch 102, a precharge path 103, a precharge control switch 104, a precharge resistor R1, the first to N-th trays 110_1 to 110_N, the rack managing unit 200, the power control unit 300, a current sensor 400, a fuse 500, and a terminal unit 600.

Charging and discharging current flows through the high current path 101 between each of the first to N-th trays 110_1 to 110_N and the terminal unit 600. The high current path 101 is a current path formed between a positive terminal 610 and each of positive electrodes of the first to N-th trays 110_1 to 110_N and between a negative terminal 620 and each of negative electrodes of the first to N-th trays 110_1 to 110_N. Relatively high current flows through the high current path 101.

The charge/discharge control switch 102 is located in the high current path 101 to control flow of the charging current and the discharging current. FIG. 3 shows that the charge/discharge control switch 102 is placed between the positive terminal 610 and each of the positive electrodes of the first to N-th trays 110_1 to 110_N. However, this is exemplary, and the charge/discharge control switch 102 can be placed between the negative terminal 620 and each of the negative electrodes of the first to N-th trays 110_1 to 110_N.

The precharge path 103 is connected in parallel with at least a part of the high current path 101 so as to precharge batteries in the first to N-th trays 110_1 to 110_N. When a battery in a low voltage state (i.e., at a lower voltage level than an operating voltage) is charged, influx current can occur in the battery due to a voltage difference between the battery and a charging device, and the battery or the charging device can be damaged by the influx current. The charging of the batteries can be started through the precharge path 103 including the precharge resistor R1. The precharge resistor R1 limits the charging current and can prevent the influx current. When the batteries are charged to a predetermined level, that is, to a level at which no inrush current occurs, the batteries can be charged through the high current path 101.

The precharge control switch 104 is formed in the precharge path 103 so as to control precharging of the batteries. The precharge control switch 104 can include a field effect transistor (FET). When the charging starts, the charge/discharge control switch 102 is turned off and the precharge control switch 104 is turned on. As a result, the charging current can be supplied to the batteries without the influx current. In some embodiments, when the batteries are charged and battery voltages increase so that the influx current does not occur, the charge/discharge control switch 102 can be turned on, and the batteries can be charged normally. Subsequently, the precharge control switch 104 can be turned off. The precharge resistor R1 is formed in the precharge path 103 together with the precharge control switch 104. The resistance value of the precharge resistor R1 can increase with an increase in temperature.

The first to N-th trays 110_1 to 110_N include the first to N-th tray batteries 110_11 to 110_N1, the first to N-th tray managing units 110_12 to 110_N2, first to N-th switches 110_13 to 110_N3, first to N-th fuses 110_14 to 110_N4, first to N-th current sensors 110_15 to 110_N5, and the first to N-th connectors 110_16 to 110_N6. The first to N-th trays 110_1 to 110_N are generally charged and discharged through the high current path 101.

Each of the first to N-th tray batteries 110_11 to 110_N1 can include at least one battery cell as its sub-unit. Various rechargeable secondary batteries can be used as battery cells. For example, secondary batteries used as battery cells can be nickel-cadmium battery, a lead storage battery, a nickel-metal hydride battery (NiMH), a lithium ion battery, a lithium polymer battery, etc.

The first to N-th tray managing units 110_12 to 110_N2 can be driven by drive voltage provided by the rack managing unit 200. The first to N-th tray managing units 110_12 to 110_N2 can monitor and transmit voltages, currents, temperatures, etc. of the first to N-th tray batteries 110_11 to 110_N1 to the rack managing unit 200.

The first to N-th switches 110_13 to 110_N3 can be respectively electrically connected between the first to N-th tray batteries 110_11 to 110_N1 and the first to N-th fuses 110_14 to 110_N4. The first to N-th switches 110_13 to 110_N3 are respectively turned on/off by switching control signals output from the first to N-th tray managing units 110_12 to 110_N2. When the first to N-th switches 110_13 to 110_N3 are turned on by the switching control signals, the first to N-th tray batteries 110_11 to 110_N1 can be connected to the high current path 101 and charged or discharged. When the first to N-th tray managing units 110_12 to 110_N2 are turned off, the switching control signals are deactivated, and the first to N-th switches 110_13 to 110_N3 can be turned off in response to the deactivated switching control signals.

The first to N-th fuses 110_14 to 110_N4 can be respectively electrically connected between the first to N-th switches 110_13 to 110_N3 and the high current path 101. When a problem occurs in any one of the first to N-th tray batteries 110_11 to 110_N1, the corresponding fuse 110_14, 110_{—}24, . . . , or 110_N4 can be melt and cut off, and the tray battery 110_11, 110_{—}12, . . . , or 110_N1 in which the problem has occurred can be completely electrically separated.

The first to N-th current sensors 110_15 to 110_N5 can sense input and output current of the first to N-th tray batteries 110_11 to 110_N1, respectively. The first to N-th tray managing units 110_12 to 110_N2 can monitor input and output current of the first to N-th tray batteries 110_11 to 110_N1 by using the corresponding first to N-th current sensors 110_15 to 110_N5, respectively.

Each of the first to N-th connectors 110_16 to 110_N6 includes the first contact 110_7 and the second contact 110_8. The first to N-th connectors 110_16 to 110_N6 are closed when the first to N-th trays 110_1 to 110_N are inserted in correct positions of slots. The first to N-th connectors 110_16 to 110_N6 are opened when the first to N-th trays 110_1 to 110_N are separated from the slots. The first to N-th connectors 110_16 to 110_N6 are electrically connected in series between a first signal line 331 and a second signal line 332 of the power control unit 300. In other words, a first terminal of the first connector 110_16 is electrically connected to the first signal line 331, and a second terminal of the first connector 110_16 is electrically connected to a first terminal of the second connector 110_26. The first terminal of the second connector 110_26 is electrically connected to the second terminal of the first connector 110_16, and a second terminal of the second connector 110_26 is electrically connected to a first terminal of the third connector 110_36. In this way, a first terminal of the N-th connector 110_N6 is electrically connected to a second terminal of the (N−1)th connector 110_N-16, and a second terminal of the N-th connector 110_N6 is electrically connected to the second signal line 332 of the power control unit 300. Because the first to N-th connectors 110_16 to 110_N6 are electrically connected in series between the first signal line 331 and the second signal line 332, the first and second signal lines 331 and 332 are electrically connected to each other only when all of the first to N-th trays 110_1 to 110_N are inserted correctly. When any one of the first to N-th trays 110_1 to 110_N is separated from a slot, the first and second signal lines 331 and 332 are electrically separated from each other.

The rack managing unit 200 can sense the voltage of the high current path 101, and can control switching operations of the charge/discharge control switch 102 and the precharge control switch 104. Also, the rack managing unit 200 can provide the drive voltage to the first to N-th tray managing units 110_12 to 110_N2, and can receive monitoring data about a voltage, current, temperature, remaining power, life span, SOC, etc. of the first to N-th tray batteries 110_11 to 110_N1 from the first to N-th tray managing units 110_12 to 110_N2 by using CAN communication. The rack managing unit 200 can provide the received monitoring data to the outside of the battery system 20 (e.g., the integrated controller 15 of FIG. 5), receive a command related to control over the battery rack 100 from the outside (e.g., the integrated controller 15), and perform an operation in accordance with the command. Also, the rack managing unit 200 can monitor the current of the high current path 101. Furthermore, the rack managing unit 200 can be driven by using drive power supplied from the first to N-th trays 110_1 to 110_N.

The power control unit 300 includes first to N-th diodes D₁ to D_{N}, a switch 310, and a divider unit 320.

The first to N-th diodes D₁ to D_{N} can be respectively electrically connected to the first to N-th tray batteries 110_11 to 110_N1 and a first node N1. The first to N-th diodes D₁ to D_{N} can transmit drive power output from the first to N-th tray batteries 110_11 to 110_N1 to the first node N1.

The switch 310 can be electrically connected to the first node N1 and the rack managing unit 200. When the switch 310 is turned on, the drive power is transmitted from the first to N-th tray batteries 110_11 to 110_N1 to the rack managing unit 200. When the switch 310 is turned off, the drive power is not transmitted to the rack managing unit 200, and the rack managing unit 200 is turned off.

The divider unit 320 can be electrically connected to the first node N1 and the first signal line 331 so as to generate the close control signal. The divider unit 320 can generate the close control signal for turning on the switch 310 by using the voltage of the first node N1. The divider unit 320 can include, for example, a voltage divider circuit including two resistors connected in series.

When the first to N-th trays 110_1 to 110_N are inserted correctly, the first contact 110_7 and the second contact 110_8 of each of the first to N-th connectors 110_16 to 110_N6 come in contact with each other, and all of the first to N-th connectors 110_16 to 110_N6 are closed. The close control signal is provided to the switch 310 through the first signal line 331, the first to N-th connectors 110_16 to 110_N6 in a close state, and the second signal line 332. The switch 310 is put in a switch turn-on state in response to the close control signal. When the switch 310 is put in the switch turn-on state, the drive power provided by the first to N-th tray batteries 110_11 to 110_N1 is supplied to the rack managing unit 200, and the rack managing unit 200 is driven. The rack managing unit 200 supplies the drive voltage to the first to N-th tray managing units 110_12 to 110_N2, and the first to N-th tray managing units 110_12 to 110_N2 are driven. The first to N-th tray managing units 110_12 to 110_N2 turn on the first to N-th switches 110_13 to 110_N3 respectively, and the rack managing unit 200 turns on the charge/discharge control switch 102 and/or the precharge control switch 104 so that the battery system 20 can be charged or discharged normally.

However, when any one of the first to N-th trays 110_1 to 110_N is separated from a slot, the first and second contacts 110_7 and 110_8 of the corresponding connector 110_16, 110_{—}26, . . . , or 110_N6 among the first to N-th connectors 110_16 to 110_N6 are separated from each other, and the corresponding connector 110_16, 110_26, . . . , or 110_N6 is opened. The close control signal is not transmitted to the second signal line 332 due to the corresponding connector 110_16, 110_26, . . . , or 110_N6 in an open state. In other words, because the corresponding connector 110_16, 110_26, . . . , or 110_N6 is opened, an open control signal is generated and input to the switch 310 through the second signal line 332. The switch 310 is put in a switch turn-off state in response to the open control signal. When the switch 310 is put in the switch turn-on state, transmittance of the drive power output from the first to N-th tray batteries 110_11 to 110_N1 to the rack managing unit 200 can be blocked, and the rack managing unit 200 is turned off. When the rack managing unit 200 is turned off, the charge/discharge control switch 102 and the precharge control switch 104 controlled by the rack managing unit 200 are turned off together, and the first to N-th trays 110_1 to 110_N are electrically separated from the terminal unit 600. Also, when the rack managing unit 200 is turned off, the first to N-th tray managing units 110_12 to 110_N2 are not supplied with the drive voltage from the rack managing unit 200 and are turned off. When the first to N-th tray managing units 110_12 to 110_N2 are turned off, the first to N-th switches 110_13 to 110_N3 managed by the first to N-th tray managing units 110_12 to 110_N2 are also turned off, and the first to N-th tray batteries 110_11 to 110_N1 are electrically separated from the high current path 101.

As described above, the first to N-th connectors 110_16 to 110_N6 mechanically sense separation of the trays 110. When any one of the trays 110 is separated from a slot, drive power supplied to the rack managing unit 200 can be blocked so that the charging or the discharging of the battery system 20 can be stopped. By substantially blocking the drive power of the rack managing unit 200, the charge/discharge control switch 102, the precharge control switch 104, and the first to N-th switches 110_13 to 110_N3 are turned off. In this way, the first to N-th tray batteries 110_11 to 110_N1 are electrically separated from the terminal unit 600, and can also be separated from each other.

An additional separation sensor can be used to sense the separation of the trays 110.

The current sensor 400 can sense the current of the high current path 101 and can transfer the value of the sensed current to the rack managing unit 200.

When there is a problem in the high current path 101, the fuse 500 can be cut off and the flow of the charging current or the discharging current can be prevented.

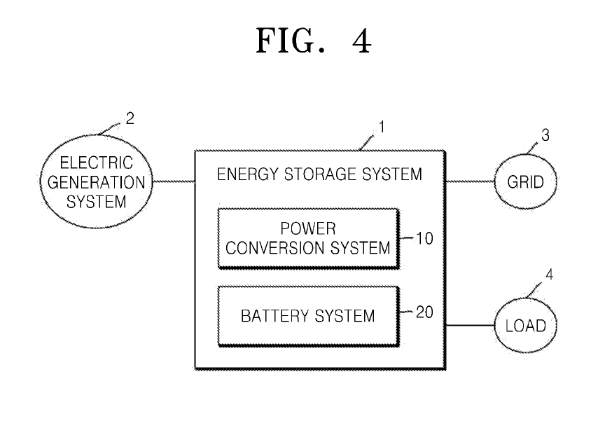

FIG. 4 is a block diagram of an energy storage system according to an embodiment and peripheral components.

Referring to FIG. 4, an energy storage system 1 supplies power to a load 4 in association with an electric generation system 2 and a grid 3. The energy storage system 1 includes a battery system 20 that stores power, and a power conversion system (PCS) 10. The PCS 10 can convert the power provided by the electric generation system 2, the grid 3, and/or the battery system 20 into a suitable form of power. The PCS 10 can supply the converted form of power to the load 4, the battery system 20, and/or the grid 3.

The electric generation system 2 can generate power from an energy source. The electric generation system 2 can supply the generated power to the energy storage system 1. The electric generation system 2 can include at least one of, for example, a photovoltaic power generation system, a wind power generation system, and a tidal power generation system. For example, the electric generation system 2 can be any electric generation system that generates power by using new renewable energy, such as solar heat or geothermal heat. The electric generation system 2 can be a high-capacity energy system by arranging a plurality of electric generation modules in parallel.

The grid 3 can include a power station, a substation, a power line, etc. When the grid 3 is in a normal state, the grid 3 can supply power to the load 4 and/or the battery system 20, or can be supplied with power from the battery system 20 and/or the electric generation system 2. When the grid 3 is in an abnormal state, power transfer between the grid 3 and the energy storage system 1 is stopped.

The load 4 can consume power generated by the electric generation system 2, power stored in the battery system 20, and/or power supplied from the grid 3. Electric devices of a home or a factory in which the energy storage system 1 is installed can be an example of the load 4.

The energy storage system 1 can store power generated by the electric generation system 2 in the battery system 20, or supply the generated power to the grid 3. The energy storage system 1 can supply power stored in the battery system 20 to the grid 3, or store power supplied from the grid 3 in the battery system 20. When the grid 3 is in the abnormal state, for example, when a power failure occurs, the energy storage system 1 can perform an uninterruptible power supply (UPS) function, thereby supplying power generated by the electric generation system 2 or power stored in the battery system 20 to the load 4.

FIG. 5 is a block diagram of an energy storage system according to an embodiment.

Referring to FIG. 5, an energy storage system 1 can include the PCS 10, the battery system 20, a first switch 30, and a second switch 40. The battery system 20 can include a battery 21 and a battery managing unit 22.

The PCS 10 can convert power provided by the electric generation system 2, the grid 3, and/or the battery system 20 into a suitable form of power. The PCS 10 can supply the converted form of power to the load 4, the battery system 20, and/or the grid 3. The PCS 10 can include a power conversion unit 11, a direct current (DC) link unit 12, an inverter 13, a converter 14, and the integrated controller 15.

The power conversion unit 11 can be a power conversion device electrically connected to the electric generation system 2 and the DC link unit 12. The power conversion unit 11 can convert power generated by the electric generation system 2 into DC link voltage and provide the DC link voltage to the DC link unit 12. The power conversion unit 11 can include a power conversion circuit, for example, a converter circuit or a rectifier circuit, according to the type of the electric generation system 2. When the electric generation system 2 generates DC power, the power conversion unit 11 can include a DC-DC converter circuit for converting the DC power into other DC power. When the electric generation system 2 generates alternating current (AC) power, the power conversion unit 11 can include a rectifier circuit for converting the AC power generated by the electric generation system 2 into DC power.

When the electric generation system 2 is a photovoltaic power generation system, the power conversion unit 11 can include a maximum power point tracking (MPPT) converter that performs MPPT to obtain as much power generated by the electric generation system 2 as possible according to a variation in insulation, temperature, etc. Also, when the electric generation system 2 generates no power, operation of the power conversion unit 11 can stop, and thus power consumed by the power conversion circuit, such as a converter circuit or a rectifier circuit can be reduced.

A problem (such as an instantaneous voltage sag in the electric generation system 2 or the grid 3 or occurrence of a peak load in the load 4) can destabilize the level of the DC link voltage. However, normal operation of the converter 14 and the inverter 13 can stabilize the level. The DC link unit 12 can be electrically connected to each of the power conversion unit 11, the converter 14 and the inverter 13 so as to maintain the DC link voltage substantially uniformly. The DC link unit 12 can include, for example, a high-capacity capacitor.

The inverter 13 can be a power conversion device electrically connected to the DC link unit 12 and the first switch 30. The inverter 13 can include an inverter that converts the DC link voltage into AC voltage and can output the AC voltage. Also, the inverter 13 can include a rectifier circuit that converts the AC voltage provided by the grid 3 into the DC link voltage. When charging, the inverter 13 can output the DC link voltage to store power of the grid 3 in the battery system 20. The inverter 13 can be a bidirectional inverter whose input and output directions can be changed.

The inverter 13 can include a filter for removing harmonics from AC voltage output to the grid 3. Also, the inverter 13 can include a phase-locked loop (PLL) circuit for synchronizing the phase of the AC voltage output of the inverter 13 with the phase of the AC voltage of the grid 3 so as to prevent or limit the generation of reactive power. Also, the inverter 13 can perform other functions, such as limiting of a voltage change range, improvement of a power factor, removal of DC components, and protection from or reduction in transient phenomena.

The converter 14 can be a power conversion device electrically connected to the DC link unit 12 and the battery system 20. The converter 14 can include a DC-DC converter that converts power stored in the battery system 20 into the DC link voltage. When discharging, the converter 14 can output the DC link voltage to the inverter 13. Also, the converter 14 can include a DC-DC converter that converts the DC link voltage output from the power conversion unit 11 and/or the DC link voltage output from the inverter 13 into DC voltage of a suitable voltage level (e.g., a charging voltage level of the battery system 20) and outputs the DC voltage to the battery system 20. The converter 14 can be a bidirectional converter whose input and output directions can be changed. When charging or discharging of the battery system 20 is not performed, operation of the converter 14 can be stopped so that power consumption can be reduced.

The integrated controller 15 can monitor states of the electric generation system 2, the grid 3, the battery system 20, and the load 4. For example, the integrated controller 15 can monitor whether a power failure has occurred in the grid 3, whether power is generated by the electric generation system 2, the amount of power generated by the electric generation system 2, an SOC of the battery system 20, the power consumption of the load 4, time, etc.

According to results of the monitoring and a predetermined algorithm, the integrated controller 15 can control operation of the power conversion unit 11, the inverter 13, the converter 14, the battery system 20, the first switch 30, and the second switch 40. For example, when a power failure occurs in the grid 3, the integrated controller 15 can control power stored in the battery system 20 or power generated by the electric generation system 2. Also, when not enough power is supplied to the load 4, the integrated controller 15 can prioritize electric devices of the load 4 and control the load 4 so that electric devices having high orders of priority can be supplied with power first. Also, the integrated controller 15 can control the charging and the discharging of the battery system 20.

The first and second switches 30 and 40 are connected in series between the inverter 13 and the grid 3 The first and second switches 30 and 40 can perform closing and opening operations according to control of the integrated controller 15, thereby controlling the flow of current between the electric generation system 2 and the grid 3. According to states of the electric generation system 2, the grid 3, and the battery system 20, the first and second switches 30 and 40 can be put in the close or open state. Specifically, when power is supplied from the electric generation system 2 and/or the battery system 20 to the load 4 or power is supplied from the grid 3 to the battery system 20, the first switch 30 is put in the close state. When power is supplied from the electric generation system 2 and/or the battery system 20 to the grid 3 or power is supplied from the grid 3 to the load 4 and/or the battery system 20, the second switch 40 is put in the close state.

When a power failure occurs in the grid 3, the second switch 40 is put in the open state and the first switch 30 is put in the close state. In other words, power is supplied from the electric generation system 2 and/or the battery system 20 to the load 4. Substantially simultaneously, power supplied to the load 4 can be prevented from flowing toward the grid 3. In this way, the energy storage system 1 can operate as a standalone system, thereby a worker who works for power cables of the grid 3 can be prevented from getting shocked by power transmitted from the battery system 20.

The first and second switches 30 and 40 can include a switching device that can withstand or handle high current, such as a relay.

The battery system 20 can receive power from the electric generation system 2 and/or the grid 3, store the received power, and supply the stored power to the load 4 and/or the grid 3.

The battery system 20 can include a battery 21 that includes at least one battery cell to store power and a battery managing unit 22 that can control and protect the battery 21. The battery 21 can include the battery rack 100 described above with reference to FIGS. 1 and 2. The battery 21 can be the battery rack 100 including the plurality of trays 110 selectively connected in parallel. The battery 21 can be the tray battery 110_1 including the plurality of battery cells selectively connected in parallel. The battery managing unit 22 can correspond to the combination of the tray managing units 110_2 and the rack managing unit 200 described above with reference to FIGS. 1 and 2.

The battery managing unit 22 is electrically connected to the battery 21, and can control overall operation of the battery system 20. For example, the battery managing unit 22 can perform an overcharge prevention function, an over-discharge prevention function, an overcurrent protection function, an overvoltage protection function, an overheat protection function, a cell balancing function, etc.

The battery managing unit 22 can obtain the voltage, current, temperature, remaining power, life span, SOC, etc. of the battery 21. For example, the battery managing unit 22 can measure a cell voltage, current, and temperature of the battery 21 by using sensors. The battery managing unit 22 can calculate the remaining power, life span, SOC, etc. based on the measured cell voltage, current, and temperature. The battery managing unit 22 can manage the battery 21 based on the measured results and the calculated results, and transmit the results to the integrated controller 15. According to the charge and the discharge control commands received from the integrated controller 15, the battery managing unit 22 can control charging and discharging operations of the battery 21.

The battery managing unit 22 can detect the terminal voltage of each battery. The terminal voltage is a voltage between the positive and negative electrodes of each battery. The battery managing unit 22 can receive information on an operation mode of the battery system 20 (e.g., the charge command or the discharge command) from the integrated controller 15.

Furthermore, the battery system 20 can include a power control unit. The power control unit provides drive power from the tray 110 to the rack managing unit 200 based on the close control signal, or blocks the drive power provided from the tray 110 to the rack managing unit 200 based on the open control signal.

As described above, according to the one or more of the above embodiments, recharging or discharging of a system is stopped by mechanically sensing separation of a tray. Therefore, instantaneous overcurrent can be prevented from flowing to the remaining trays that have not been separated, or a voltage difference can be prevented from occurring between trays so that the system can be driven safely.

The particular implementations shown and described herein are illustrative examples of the invention and are not intended to otherwise limit the scope of the invention in any way.

Accordingly, the invention is not limited to the embodiments described herein, and the following claims and all equivalents or equivalent modifications of the claims come within the spirit of the invention.

What is claimed is:

1. A battery system, comprising:
a plurality of trays each including a battery and a first contact, wherein the batteries are configured to provide drive power;
a rack including a plurality of slots configured to respectively receive the trays, wherein each slot comprises a second contact corresponding to the first contact;
a rack manager configured to charge a load based on the drive power; and
a power controller configured to i) transfer the drive power from the batteries to the rack manager when the first and second contacts are connected and ii) not transfer the driver power from the batteries to the rack manager when at least one of the first contacts is separated from the corresponding second contact.

2. The battery system of claim 1, wherein the power controller is configured to i) provide a close control signal when the first and second contacts are connected and ii) provide an open control signal when the at least one first contact is separated from the corresponding second contact, wherein the rack manager is configured to charge the load based on the close control signal and stop charging the load based on the open control signal.

3. The battery system of claim 2, wherein the power controller comprises:
a plurality of diodes respectively electrically connected to the trays; and
a switch electrically connected between the diodes and the rack manager, wherein the switch is configured to be respectively closed and opened based on the close control signal and the open control signal.

4. The battery system of claim 3, further comprising a divider configured to output the close control signal from a node between the diodes and the switch.

5. The battery system of claim 4, wherein the divider is configured to output the open control signal from the node.

6. The battery system of claim 1, wherein each of the trays comprises:
a battery tray;
a tray manager configured to be driven by the drive power, wherein the tray manager is configured to monitor an operation state of the battery tray, and wherein the tray manager is configured to provide the monitored operation state to the rack manager; and
a switch configured to electrically connect the battery tray to a high current path based on a switching control signal received from the tray manager.

7. The battery system of claim 6, wherein the switch is configured to be turned off when the tray manager is turned off.

8. The battery system of claim 1, further comprising a charge/discharge control switch placed in a high current path between the trays and a voltage terminal, wherein the charge/discharge control switch is configured to control a current flow in the high current path based on a first switching control signal received from the rack manager.

9. The battery system of claim 8,
wherein the charge/discharge control switch is configured to be turned off when the rack manager is turned off.

10. The battery system of claim 8, further comprising a precharge circuit including a precharge control switch and a precharge resistor, wherein the precharge circuit is located in a precharge path connected in parallel with at least a portion of the high current path, and wherein the precharge circuit is configured to be controlled based on a second switching control signal received from the rack manager.

11. The battery system of claim 10, wherein the precharge control switch is configured to be turned off when the rack manager is turned off.

12. An energy storage system, comprising:
a battery system including:
a plurality of trays each including a battery and a first contact, wherein the batteries are configured to provide drive power;
a rack including a plurality of slots configured to respectively receive the trays, wherein each slot comprises a second contact corresponding to the first contact;
a rack manager configured to charge a load based on the drive power; and
a power controller configured to i) transfer the drive power from the batteries to the rack manager when the first and second contacts are connected and ii) not transfer the driver power from the batteries to the rack manager when at least one of the first contacts is separated from the corresponding second contact; and
a power conversion system configured to convert the drive power between the load and the battery system.

13. An energy storage system, comprising:
a battery system, including:
a plurality of trays each including a battery and a first contact, wherein the batteries are configured to output power;
a rack including a plurality of slots configured to respectively receive the trays, wherein each slot comprises a second contact corresponding to the first contact; and
a rack manager configured to charge a load based on the power when the first and second contacts are connected and stop charging the load when at least one of the first contacts is separated from the second contact corresponding to the first contact; and
a power conversion system configured to convert the power between the load and the battery system.

14. The energy storage system of claim 13, wherein the rack manager is configured to sense a close control signal when the first and second contacts are connected and sense an open control signal when the at least one first contact is separated from the corresponding second contact, and wherein the rack manager is configured to charge the load based on the close control signal and stop charging the load based on the open control signal.

15. The energy storage system of claim 14, wherein the battery system further includes a power controller configured to transfer the power from the batteries to the rack manager.

16. The energy storage system of claim 15, wherein the power controller comprises:
a plurality of diodes respectively electrically connected to the trays; and
a switch electrically connected between the diodes and the rack manager, wherein the switch is configured to be respectively closed and opened based on the close control signal and the open control signal.
